(19) United States
(12) Patent Application Publication
(10) Pub. No.: US 2011/0066416 A1
(43) Pub. Date: Mar. 17, 2011

(54) METHOD AND SYSTEM FOR SIMULATION AND VERIFICATION OF COMMUNICATION DEVICES

(76) Inventor: Eric Sachs, San Diego, CA (US)

(21) Appl. No.: 12/574,667

(22) Filed: Oct. 6, 2009

Related U.S. Application Data
(60) Provisional application No. 61/242,698, filed on Sep. 15, 2009.

(51) Int. Cl. G06G 7/62; G06F 17/50

(52) U.S. Cl. 703/13

(57) ABSTRACT

Aspects of a method and system for simulation and verification of communication devices are provided. In this regard, a wireless communication system that comprises at least a wireless signal source and the wireless communication device may be simulated utilizing a plurality of configurable modules that comprises: a module under test, a processor module, and a signal source module. A subset of processor modules may be selected based on test cases to be performed for the simulation. The selection of the subset of processor modules may be performed without recompiling the processor module. A subset of signal source modules may be selected based on characteristics of a signal source to be modeled during the simulation. The selection of the subset of signal source modules may be performed without recompiling the signal source module.

### CROSS-REFERENCE TO RELATED APPLICATIONS/INCORPORATION BY REFERENCE

This patent application makes reference to, claims priority to and claims benefit from U.S. Provisional Patent Application Ser. No. 61/242,698 filed on Sep. 15, 2009.

The above stated application is hereby incorporated herein by reference in its entirety.

### FIELD OF THE INVENTION

Certain embodiments of the invention relate to design verification. More specifically, certain embodiments of the invention relate to a method and system for simulation and verification of communication devices.

### BACKGROUND OF THE INVENTION

With the rapidly increasing dependence on electronic communications and the accompanying efforts to make these communications faster, more powerful, and cheaper, the complexity of designing communications systems is also increasing. In this regard, as more and more features are packed into smaller and smaller devices, verification of those devices becomes increasingly costly and time consuming. For example, mobile communication devices, such as handsets or laptops, are continuously required to support more and faster communication protocols and to perform an increasingly diverse set of functions. However, each additional feature added to a communication device may require a substantial amount of testing for that device. Furthermore, because building prototypes of such communication devices is often infeasible due to time and/or money constraints, simulation is often relied on for much of the testing of such communication devices.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for simulation and verification of communication devices, substantially as illustrated by and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary wireless communication system, in connection with an embodiment of the invention.

FIG. 2 is a diagram illustrating a computing system operable to perform simulation of electronics systems based on models defined utilizing one or more software programming languages and/or one or more hardware description languages (HDLs), in accordance with an embodiment of the invention.

FIG. 3A is a diagram of an exemplary software-defined and/or HDL-defined model of a wireless communication system, in accordance with an embodiment of the invention.

FIG. 3B is a diagram of an exemplary software-defined and/or HDL-defined model of a wireless communication system, in accordance with an embodiment of the invention.

FIG. 3C is a diagram of an exemplary processor module, in accordance with an embodiment of the invention.

FIG. 3D is a diagram of an exemplary signal source module, in accordance with an embodiment of the invention.

FIG. 3E is a diagram illustrating exemplary VHDL configuration constructs, in accordance with an embodiment of the invention.

FIG. 4 is a diagram of an exemplary software-defined and/or HDL-defined model of a wireless communication system, in accordance with an embodiment of the invention.

FIG. 5 is a flowchart illustrating exemplary steps for simulation of a wireless communication system, in accordance with an embodiment of the invention.

### DETAILED DESCRIPTION OF THE INVENTION

Certain embodiments of the invention may be found in a method and system for simulation and verification of communication devices. In various embodiments of the invention, a wireless communication system that comprises at least a wireless signal source and the wireless communication device may be simulated utilizing a plurality of configurable modules that comprises: a MUT1, a processor module, and a signal source module. The MUT1 may model at least a portion of a design, operation and/or functionality of the wireless communication device to be tested. The processor module may model operation of a processor. The signal source module may model operation of the wireless signal source. The processor module may be dynamically programmed during the simulation such that a subset of, for example, a plurality of VHDL entity-architecture pairs is selected and utilized for the simulation. The subset of VHDL entity-architecture pairs may be selected based on test cases to be performed for the simulation. The selection of the subset of VHDL entity-architecture pairs of the processor module may be performed without recompiling the processor module. The signal source module may be dynamically programmed during the simulation such that a subset of, for example, a plurality VHDL entity-architecture pairs is selected and utilized for the simulation. The subset of VHDL entity-architecture pairs may be selected based on characteristics of a signal source to be modeled during the simulation. The selection of the subset of VHDL entity-architecture pairs of the signal source module may be performed without recompiling the signal source module.

During the simulation, the processor module may control and/or interface with other ones of the plurality of configurable modules. The signal source module may model a base station, and the signal source module may be programmed during simulation based on one or more wireless protocols utilized by the modeled base station. Exemplary wireless protocols comprise GSM, EDGE, UMTS, HSDPA, HSUPA, WiMAX, LTE, and CDMA2000, EV-DO. During the simulation, the processor module may provide parameters of a wireless signal to the signal source module, and the signal source module may generate data corresponding to one or more frames of the wireless signal based on the parameters. The design and/or functionality of the communication device to be tested may comprise at least a first subsystem coupled to an input of the communication device and a second subsystem having an input coupled to an output of the first subsystem. The MUT1 may comprise at least one test multiplexer module that may enable simulating an input signal of the communication device bypassing the first subsystem and being applied to the second subsystem.

The plurality of modules may comprise a reference module that models the design of the communication device to be tested. The reference module may be defined utilizing a software programming language, and simulation results from the reference module may be compared to simulation results from the MUT1. The plurality of modules may be compiled prior to simulating the wireless communication system. During simulation, data corresponding to states and/or parameters of the MUT1 may be provided to the processor module, and the processor module may compare the data to expected data.

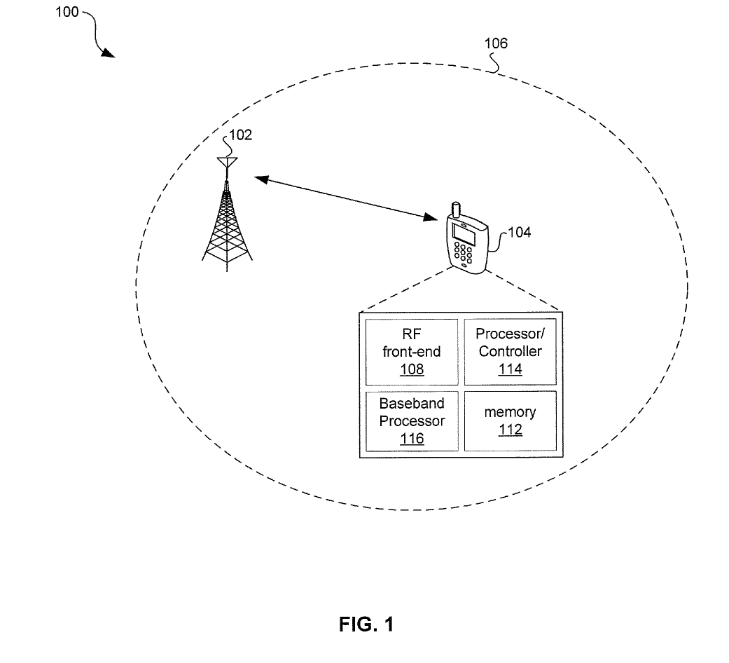

FIG. 1 is a diagram illustrating an exemplary wireless communication system, in connection with an embodiment of the invention. Referring to FIG. 1, there is shown a wireless communication system 100 comprising an antenna 102 and a wireless device 104. The antenna 102 may comprise suitable logic, circuitry, and/or code that may enable wireless communication of voice and/or data with the wireless device 104. The antenna 102 may comprise, for example, a cellular and/or WiMAX base station. The antenna 102 may communicate with the wireless device 104 over at least one of a plurality of wireless communication technologies that may comprise cellular communication technologies, for example. The antenna 102 may provide a coverage area 106 over which the wireless device 104 may communicate with the antenna 102. The antenna 102 may be communicatively coupled to at least one of a plurality of communication networks, such as cellular networks, for example, that enable communication between the wireless device 104 and other devices communicatively coupled to the corresponding communication network.

The wireless communication device 104 may comprise suitable logic, circuitry, and/or code that may enable wireless communication of voice and/or data with the antenna 102. The wireless communication device 104 may enable communication over a plurality of wireless communication technologies that may comprise cellular technologies. For example, the wireless device 104 may support WCDMA/EDGE (WEDGE) technologies. In another example, the wireless device 104 may support HSDPA/WCDMA/EDGE (HEDGE) technologies. Notwithstanding, aspects of the invention need not be limited to these exemplary combinations of wireless communication technologies supported by the wireless communication device 104. For example, the wireless device 104 may support LTE, WiMAX, HSDPA, HSUPA, CDMA2000, GPRS, EDGE, and/or GSM wireless communication technologies or wireless protocols. In an exemplary embodiment of the invention, the wireless communication device 104 may comprise an RF front-end 108, a baseband processor 116, a processor 114, and memory 112. The various components of the wireless communication device 104 may be realized, for example, on one or more integrated circuits.

The RF front-end 108 may comprise suitable logic, circuitry, and/or code that may enable processing baseband signals to generate RF signals for transmission, and processing received RF signals to generate baseband signals. The RF front-end 108 may be operable to up-convert baseband signals to an RF signal and/or down-convert received RF signals to baseband. In this regard, the RF front-end 108 may be operable to generate signals, such as local oscillator signals, for the up-converting, down-converting, modulating, demodulating, or otherwise processing received and/or to-be-transmitted RF signals. In some instances, the RF front-end 108 may be operable to perform digital-to-analog conversion of baseband signals prior to up-conversion and/or analog-to-digital conversion of baseband signals after down-conversion.

The baseband processor 116 may comprise suitable logic, circuitry, and/or code that may enable processing and/or handling of baseband frequency signals. In this regard, the digital baseband processor 116 may process or handle signals received from the RF front-end 108. The baseband processor 116 may also provide control and/or feedback information to the RF front-end 108 based on information from the processed signals. The baseband processor 114 may communicate information and/or data from the processed signals to the processor 114 and/or to the memory 112. Moreover, the baseband processor 116 may receive information from the processor 114 and/or to the memory 112, which may be processed and transferred to the RF front-end 108 for transmission.

The memory 112 may comprise suitable logic, circuitry, and/or code that may enable storage of data and/or other information utilized by the wireless communication device 104. For example, the memory 112 may be utilized for storing processed data generated by the baseband processor 116 and/or the processor 114. The memory 112 may also be utilized to store information, such as configuration information, that may be utilized to control the operation of at least one block in the wireless communication device 104. For example, the memory 112 may comprise information necessary to configure the wireless communication device 104 to enable receiving signals in the appropriate frequency band.

The processor 114 may comprise suitable logic, circuitry, and/or code that may enable control and/or data processing operations for the wireless communication device 104. The processor 114 may be utilized to control at least a portion of the RF front-end 108, the baseband processor 116, and/or the memory 112. In this regard, the processor 114 may generate at least one signal for controlling operations within the wireless communication device 104. The processor 114 may also enable execution of applications that may be utilized by the wireless communication device 104. For example, the processor 114 may execute applications that may enable displaying and/or interacting with content received via RF signals in the wireless communication device 104.

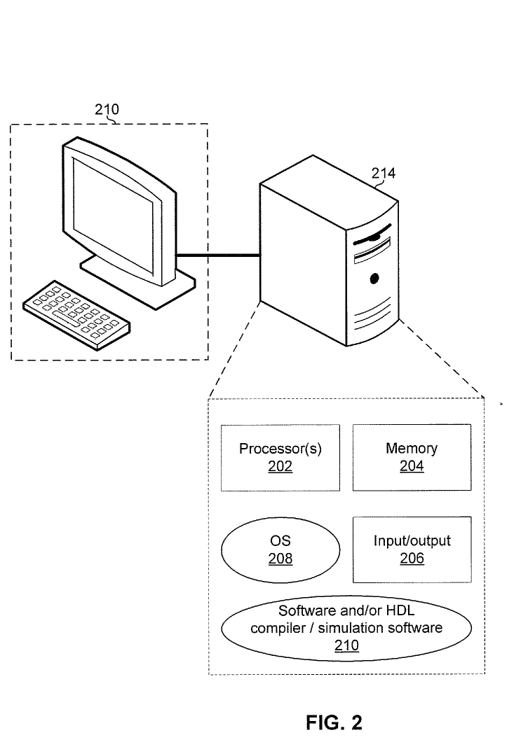

FIG. 2 is a diagram illustrating a computing system operable to perform simulation of electronics systems based on models defined utilizing one or more software programming languages and/or one or more hardware description languages (HDLs), in accordance with an embodiment of the invention. Referring to FIG. 2 there is shown a computing system 214 and peripherals 210.

The peripherals may comprise, for example, a monitor, a keyboard, a mouse, and speakers that may enable a user to interface with the computing system 214.

In various embodiments of the invention, the computing system 214 may comprise, for example, a personal computer, a server, and/or a cluster of processors, servers and/or personal computers. The computing system 214 may comprise suitable logic, circuitry, interfaces, and/or code that may be operable to execute programs for running simulations. In this regard, the computing system 214 may comprise one or more processors 202, memory 204, and input and/or output (I/O) circuitry 206 that may be operable to run an operating system (OS) 208 and compiler and/or simulation software 210.

The I/O circuitry 206 may be operable to process, format, and/or convey information between the computing system 214 and the peripherals 210. For example, the I/O circuitry 206 may be operable to output video and/or audio to the peripherals 210 and to process input, such as keystrokes and mouse clicks, from the peripherals 210.

The memory 204 may comprise suitable logic, circuitry interfaces, and/or code that may be operable to store information. In this regard, the memory 204 may store, for example, one or more lines of code corresponding to the OS 208, one or more lines of code corresponding to the compiler and/or simulation software 210, one or more lines of code corresponding to a model of a wireless system to be simulated via the software 210, and data generated during simulation.

The processor(s) 202 may comprise suitable logic, circuitry, interfaces, and/or code that may be operable to fetch and execute instructions. Based on instructions executed, the processor(s) 202 may be operable to perform computations, write information to the memory 204, read information from the memory 204, exchange information with the input/output circuitry 206, and/or otherwise control operations of the computing system 214. In this manner, the processor(s) 202 may run the operating system 208 and the compiler and/or simulation software 210.

The OS 208 may comprise, for example, Windows, Linux, or a Unix based operating system. The OS 208 may be operable to control and/or manage allocation and/or use of the processor 202, the memory 204, and the I/O circuitry 206. In this manner, the OS 208 may provide an interface between the hardware—the processor 202, the memory 204, and the I/O circuitry 206—and the software 210.

The compiler and/or simulation software 210 may comprise, for example, one or more programs that are operable to compile code which may be a written in one or more software programming languages, such as C++ and/or Java, and/or written in one or more HDLs, such as Verilog, System Verilog, and/or VHDL. Furthermore, after compiling the code, the software 210 may be operable to simulate operation of hardware modeled by the HDL(s).

In operation, a user may enter or load one or more modules written in one or more software languages and or HDLs and the code may be stored in the memory 204. The user may then invoke the software 210 to compile the modules and run a simulation. In an exemplary embodiment of the invention, the modules may model one or more portions of the wireless communication device 104 and then simulation of the modules may enable testing the portions of the wireless communication device 104. In this manner, design and/or operation of the portions of the wireless communication device 104 may be tested without having to actually build the hardware of the communication device.

For example, in a typical design cycle, a behavioral or register transfer level (RTL) model of the wireless communication device 104, or portion thereof, may be written utilizing a combination of one or more software programming languages and one or more HDLs. The behavioral or RTL model, comprising one or more modules, may be compiled and simulated. Errors in the design may be detected via the simulation, and corrections may be made to the behavioral or RTL models. One or more iterations may take place until the design is verified. Once the design is verified, the HDL portions of the model may be synthesized to generate a netlist that represents corresponding hardware. The netlist may be utilized to, for example, program a FPGA and/or to build an application specific integrated circuit (ASIC). The software portion of the model may then, for example, be programmed into the FPGA or the ASIC, and/or into a processor that interfaces with the FPGA or ASIC.

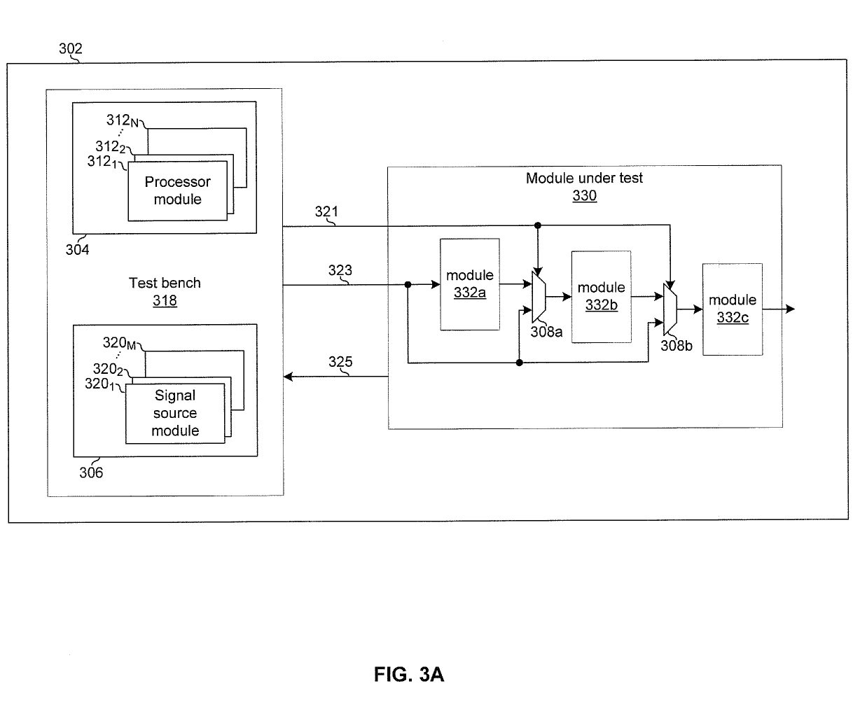

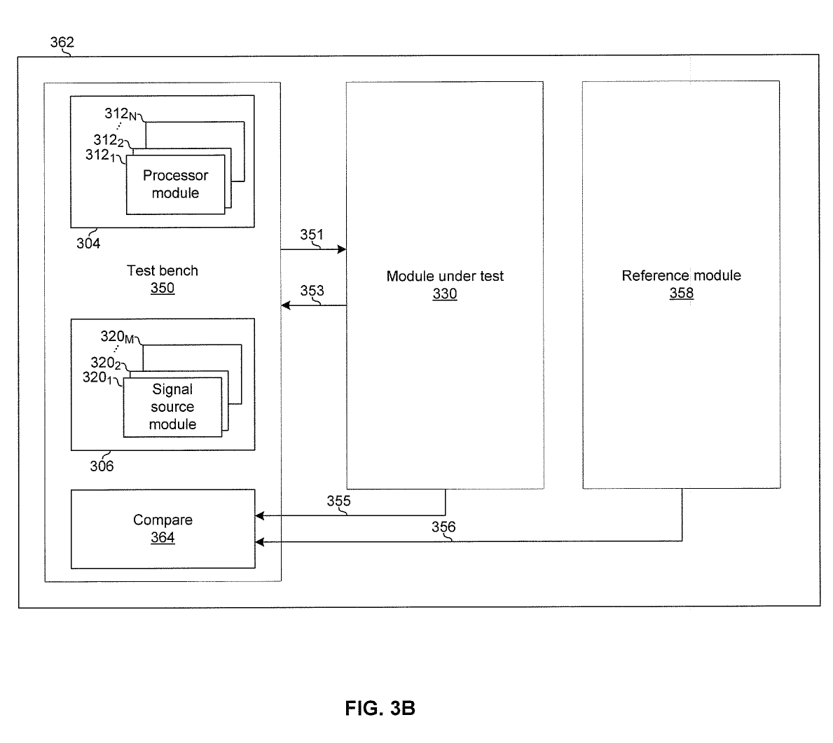

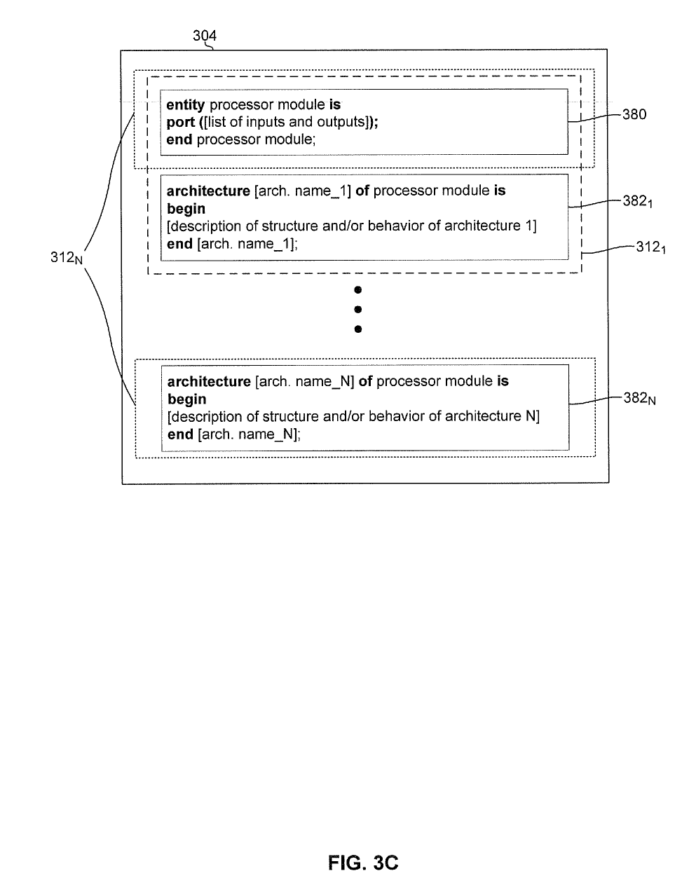

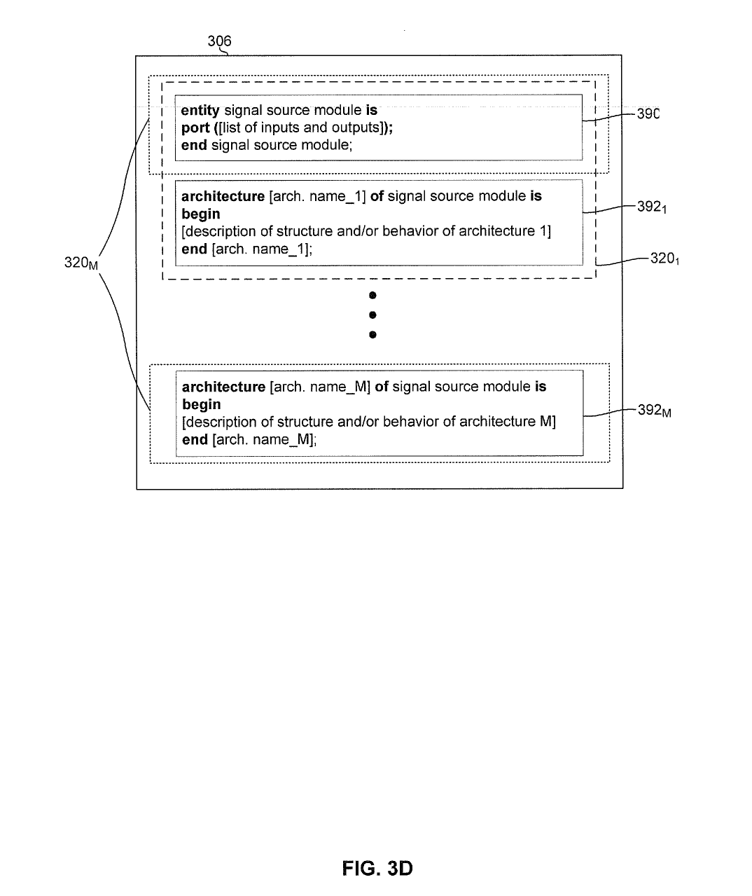

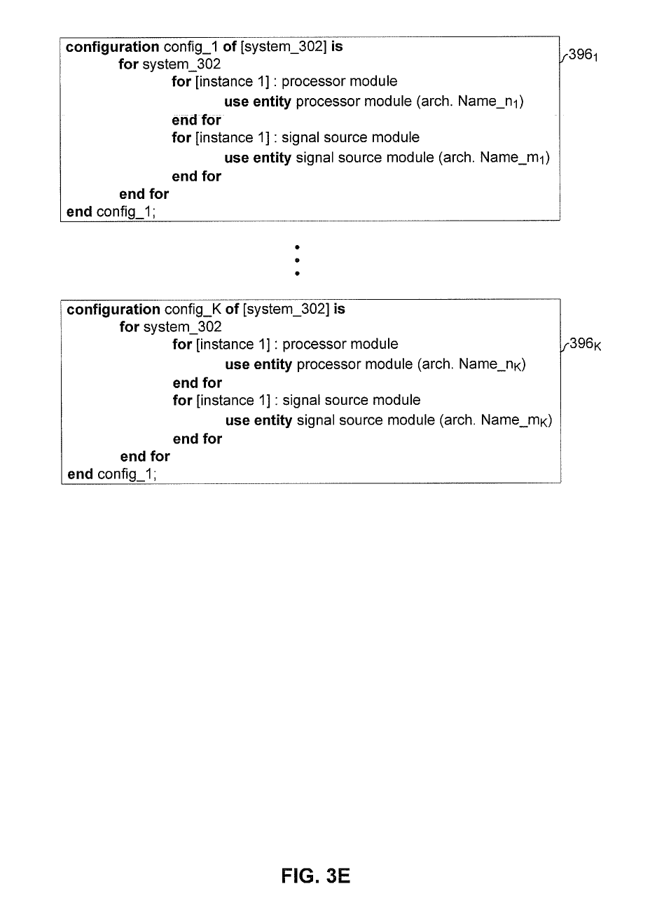

FIG. 3A is a diagram of an exemplary software-defined and/or HDL-defined model of a wireless communication system, in accordance with an embodiment of the invention. Referring to FIG. 3A, the wireless communication system model 302 comprises one or more lines of code corresponding to a test bench module 318 and one or more lines of code corresponding to a MUT1 330.

It should be noted that “module” as utilized herein does not necessarily imply the use of a particular software programming language or HDL. That is to say, a “module” or may comprise one or more lines of code written in any software programming langue, HDL, or combination thereof. Furthermore, each module may utilize other modules through, for example, function calls, compiler directives, or instantiation of one module in another.

The test bench module 318 may comprise one or more lines of code written in a software programming language and/or a HDL that enable simulation simulate various components, inputs, and/or outputs of a wireless communication system, such as the wireless communication system 100 (FIG. 1). The test bench module 318 may be partitioned into one or more modules which may comprise, for example, a processor module 304 and a signal source module 306. The processor module 304 may, in turn, comprise a plurality of processor modules 312₁-312_{N}, where N is a positive integer. The signal source module 306 may, in turn, comprise a plurality of signal source modules 312₁-312_{M}, where M is a positive integer.

The processor module 304 may comprise one or more lines of code written in a software programming language and/or a HDL that enable simulation of a processor such as an ARM, a PIC, a MIPS, or any RISC processor. The processor module 304 may comprise a plurality of modules 312. The processor module 304 may be configurable after compiling and before and/or during simulation to select which of the one of more of the processor modules 312 may be active and/or utilized during simulation. In an exemplary embodiment of the invention, the processor module 304 may be configured via one or more VHDL configuration constructs. Exemplary configuration constructs are depicted in FIG. 3E. In VHDL, a module may comprise one or more lines of code that describe the interface—inputs and outputs—of the module, and one or more lines of code that describe the behavior of the module. The lines of code that describe the interface are an “entity” construct and the lines of code are an “architecture” construct. Accordingly, a module described in VHDL typically comprises a single entity-architecture pair. In an exemplary embodiment of the invention, however, the processor module 304 may comprise a plurality of VHDL entity-architecture pairs, where each of those VHDL entity-architecture pairs corresponds to a module 312. Such an exemplary embodiment is depicted in FIG. 3C. In FIG. 3C, the processor module 304 comprises an entity construct 380 and a plurality of architecture constructs 382₁-382_{N}. In this regard, the processor module 312ₙ may comprise the entity construct 380 and the architecture constructs 382ₙ, where n is an integer between 1 and N. That is, the processor module 304 may be configured for a particular simulation by selecting which of the architecture constructs 382₁-382_{N} are paired with the entity construct 380 for that particular simulation. Each architecture construct 382ₙ may be, for example, a behavioral model or an RTL model.

Returning to FIG. 3A, the signal source module 306 may comprise one or more lines of code written in a software programming language and/or a HDL that may simulate a wireless communication signal source, such as the antenna 102 (FIG. 1). The signal source module 306 may comprise a plurality of signal source modules 320. The signal source module 306 may be configurable after compiling and before and/or during simulation to select which of the one of more of the signal source modules 320 may be active and/or utilized during simulation. In an exemplary embodiment of the invention, the signal source module 306 may comprise a plurality of VHDL entity-architecture pairs, where each of those VHDL entity-architecture pairs corresponds to a module 320. Such an exemplary embodiment is depicted in FIG. 3D. In FIG. 3D, the signal source module 306 comprises an entity construct 390 and a plurality of architecture constructs 392₁-392_{M}. In this regard, the signal source module 312ₘ may comprise the entity construct 390 and the architecture constructs 392ₘ, where m is an integer between 1 and M. That is, the signal source module 306 may be configured for a particular simulation by selecting which of the architecture constructs 392₁-392_{M} are paired with the entity construct 390 for that particular simulation. Each architecture construct 392ₘ may be, for example, a behavioral model or an RTL model.

Returning to FIG. 3A, in an exemplary embodiment of the invention, each of the modules 320 may correspond to a particular wireless communication protocol such as LTE, WiMAX, HSDPA, HSUPA, CDMA2000, GPRS, EDGE, and GSM. For example, a first signal source module 320₁ may model a base station operable to generate UMTS frames, a second signal source module 320₂ may model a base station operable to generate HSDPA frames, and a third signal source module 320₃ may model a base station operable to generate LTE frames.

The MUT1 330 may comprise one or more lines of code written in a software programming language and/or a HDL. The MUT1 330 may model and/or describe at least a portion of the wireless communication device 104 (FIG. 1). In an exemplary embodiment of the invention, the MUT1 330 may comprise a plurality of modules 332a-332c, each of which may be operable to perform or implement various functions. For example, the modules 332a-332c may correspond to subsystems, such portions of the RF front end 108 and/or the baseband processor 116, of the wireless communication device 104. In various embodiments of the invention, the MUT1 330 may comprise one or more test-multiplexer modules 308.

In operation, the processor module 304 may, during simulation, control configuration and/or operation of the other modules of the test bench 318 and/or the MUT1 330. In this regard, a plurality of modules 312 may be compiled and then one or more of the compiled modules 312 may be selected for use during simulation. In an exemplary embodiment of the invention, the selection may be made via one or more VHDL configuration constructs. Exemplary configuration constructs are depicted in FIG. 3E. Accordingly, portions of the processor module 304 may not be utilized during test cases in which those portions are not necessary for testing the MUT1 330. In this manner, simulation time may be sped up by reducing code to be executed and/or data to be generated and/or tracked during simulation. For example, the selected or active module 312_{X} of the processor module 304 may control when frames are generated by the signal source module 306 and/or characteristics of frames generated by the signal source module 306. Also, the selected or active module 312_{X} of the processor module 304 may, during simulation, verify data generated by the MUT1 330, where the generated data may correspond to various test points, parameters, and/or states of the wireless communication device 104.

During simulation, a particular signal source module 320_{X} may be selected based on the wireless communication protocols for which the MUT1 330 is to be tested. In this regard, a plurality of modules 320 may be compiled and then one or more of the compiled modules 320 may be selected for use during simulation. In an exemplary embodiment of the invention, the selection may be made via one or more VHDL configuration constructs. Exemplary configuration constructs are depicted in FIG. 3E. Accordingly, portions of the signal source module 306 utilized during test cases in which those portions are not necessary for testing the MUT1 330. In this manner, simulation time may be sped up by reducing code that must be executed and/or data that must be generated and/or tracked during simulation. For example, a selected processor module 312_{X} of the processor module 304 may direct a test case that tests whether the MUT1 330 can property receive and demodulate an HSDPA frame. Accordingly, the selected processor module 312_{X} may select the signal source module 320₂ that models a base station operable to generate HSDPA frames. Furthermore, the selected processor module 312_{X} may control or instruct the signal source module 320₂ to generate HSDPA frames having particular characteristics, where the characteristics may comprise, for example, a data rate and/or encoding method, such as turbo encoding or convolutional encoding, of the HSDPA frames. In this regard, the signal source module 306 may be configurable to generate data corresponding to frames of different wireless protocols without re-compiling the signal processor module 306.

In some instances, it may be desirable to bypass the module 332a to test the module 332b or to bypass both modules 332a and 332b to test the module 332c. Accordingly, the MUT1 330 may comprise one or more lines of code that correspond to test multiplexers modules 308a and 308b. Furthermore, the processor module 304 may generate control signals 321 to configure the test-multiplexer modules 308a and 308b, appropriately.

FIG. 3B is a diagram of an exemplary software-defined and/or HDL-defined model of a wireless communication system, in accordance with an embodiment of the invention. Referring to FIG. 3B, there is shown a wireless communication system model 362 which comprises a test bench module 350, a MUT1 330, and a reference module 358.

The wireless communication system model 362 may be similar in many respects to the model 302 described with respect to FIG. 3A, but may differ in that the model 362 may comprise a reference module 358 and a comparison module 364.

The reference module 358 may comprise one or more lines of code that simulate operation of a known good or “reference” design. In this regard, data generated by the reference module 358 during simulation may be utilized as a basis of comparison for data generated by the MUT1 330. In this manner, the MUT1 330 may be verified if the data it generates during simulation matches the data generated by the reference module 358 during simulation. Accordingly, the comparison module 364 may be operable compare the data generated by the MUT1 330 with the data generated by the reference module 358. In one embodiment of the invention, the reference module 358 may comprise a software model—written in C++, for example—that simulates an ideal wireless communication device 104 whereas the MUT1 330 may comprise a HDL module that takes into account, for example, timing, parasitics, and other real world effects. In another embodiment of the invention, the reference module 358 may comprise a HDL model of a previous generation of the wireless communication device 104 and the MUT1 330 may comprise a HDL model of the next generation of the wireless communication device 104.

FIG. 3E is a diagram illustrating exemplary VHDL configuration constructs, in accordance with an embodiment of the invention. Referring to FIG. 3B there is shown configurations 396₁-396_{K} of the wireless communication system model 302, where K is an integer greater than or equal to 1. For each configuration, 396ₖ, architecture nₖ of the processor module may be selected and architecture mₖ of the signal source module may be selected, where nₖ may be any integer between 1 and N, and mₖ may be any integer between 1 and M.

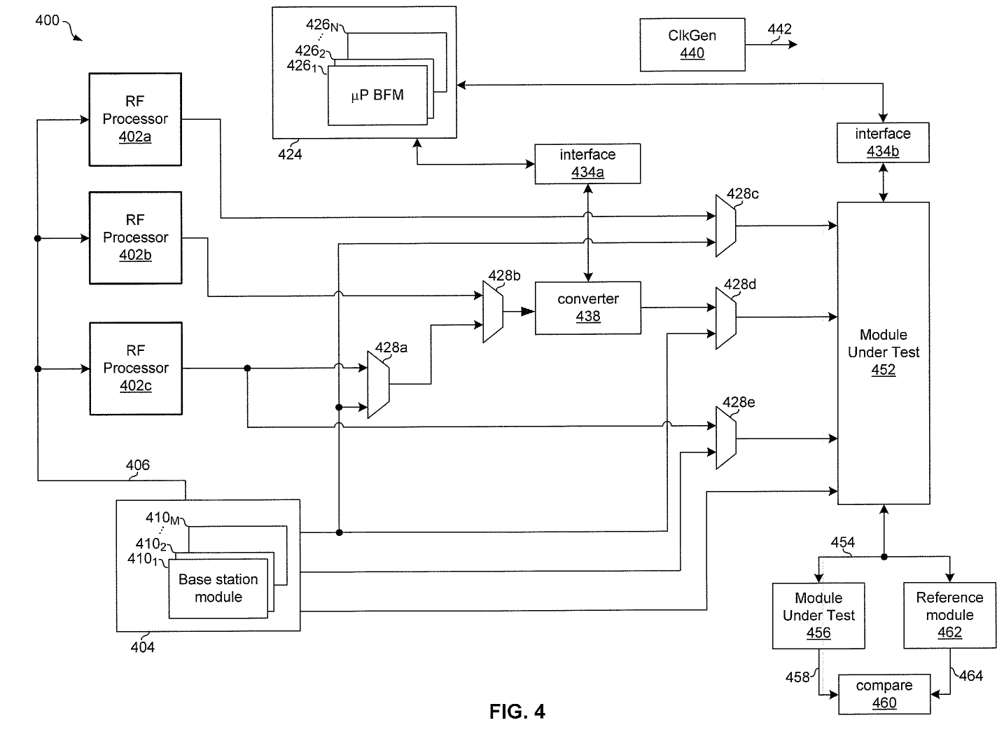

FIG. 4 is a diagram of an exemplary software-defined and/or HDL-defined model of a wireless communication system, in accordance with an embodiment of the invention. Referring to FIG. 4, there is shown a wireless communication system model 400 comprising baseband processor modules 402a-402c, base station module 404, stimulus module 408, a microprocessor (μP) bus functional model (BFM) 424, multiplexers 428a-428e, interfaces 434a-434b, module under test (MUT1) 452, module under test (MUT2) 456, reference module 462, and comparison module 460.

The MUT1 452 may be similar to the MUT1 330 described with respect to FIGS. 3A and 3B. In an exemplary embodiment of the invention, the MUT1 452 may comprise one or more lines of code written in a software programming language and/or a HDL that model or describe a modem of a wireless communication device 104 (FIG. 1). In this regard, the modem represented by the MUT1 452 may be operable to perform modulation, demodulation, encoding, decoding, error correction, rate conversion, or other operations for processing received and/or to-be-transmitted wireless signals.

The RF processor modules 402a-402c may each comprise one or more lines of code written in a software programming language and/or a HDL that may model or describe various RF processors which may be within a particular wireless communication device 104. For example, different generations of a wireless communication device 104 and/or different vendors or carriers of a wireless communication device 104 may utilize different RF processors. Thus, the wireless communication model 400 enables simulating these different devices without recompiling the model 400.

The base station module 404 may be similar in many respects to the signal source module 306 described with respect to FIGS. 3A and 3B. The μP bus functional model (BFM) 424 may be similar in many respects to the processor module 304 described with respect to FIGS. 3A and 3B. The comparison module 460 may be similar in many respects to the comparison module 364 described with respect to FIG. 3B. The reference module 462 may be similar in many respects to the reference module 358 described with respect to FIG. 1.

The converter module 438 may comprise one or more lines of code that, during simulation, may convert or reformat data. For example, during simulation the converter module 438 may generate data corresponding to a serial bitstream into data corresponding to a parallel bitstream, or visa versa.

The interfaces 434a-434b, may comprise one or more lines of code that, during simulation, may convert or reformat data. For example, a particular processor module 424 and a particular MUT1 452 may send and/or receive data formatted according to different protocols. Accordingly, the interface 434b may reformate or “translate” the information such that data output by one is comprehensible to the other. Accordingly, various processor modules and modules under test become interchangeable by utilizing an appropriate interface module 434b. That is to say, changing to a different MUT1 that utilizes a different communication protocol does not necessarily require a change to a different processor module, and visa versa. Similarly, the interface 434a may enable a communication protocol utilized by the converter module 438 to be changed and/or designed independent of the communication protocol utilized by the processor module 424.

The multiplexers 428a-428e may comprise one or more lines of code that, during simulation, may control which modules process data prior to the data being provided to the MUT1 452. In this regard, the ARM BFM 424 may control the multiplexers 428a-428e based on a test case to be run.

MUT2 456, may comprise one or more lines of code that, during simulation, enable controlling the MUT1 452 to test, for example, HSUPA functionality of the MUT1 452.

The clk gen module 442 may comprise one or more lines of code that, during simulation, generate data corresponding to one or more clock signals.

In operation, during simulation on a computing system, the wireless communication system model 400 may enable testing operation of the MUT1 452. In an exemplary embodiment of the invention, the MUT1 452 may model or describe at least a portion of a wireless communication device and thus operation of the wireless communication device may be tested.

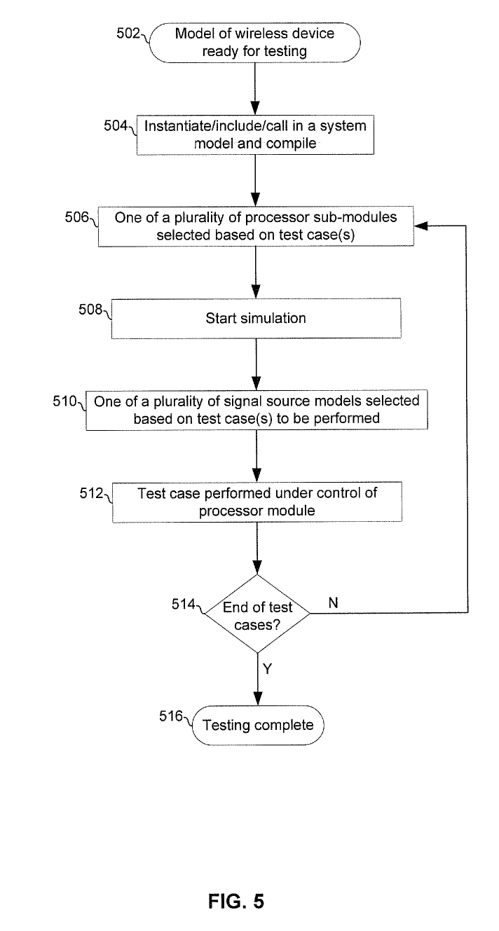

FIG. 5 is a flowchart illustrating exemplary steps for simulation of a wireless communication system, in accordance with an embodiment of the invention. Referring to FIG. 5, the exemplary steps may begin with step 502 in which a model or description of a portion of a wireless communication device is ready for testing. For example, the portion of the wireless communication device 104 may be designed and/or described utilizing an HDL and it may be desirable to test the design and/or description via simulation rather than the more costly steps of synthesizing the HDL and implementing the design in an FPGA or ASIC. The simulation may be run on the computing platform 214. Subsequent to step 502, the exemplary steps may advance to step 504.

In step 504, the HDL corresponding to the portion of the wireless communication device to be tested—the MUT1 330—may be instantiated, included, called via a function call, or otherwise associated with a test bench module 350. The test bench 350 and MUT1 330 may then be compiled. Subsequent to step 506, the exemplary steps may advance to step 506.

In step 506, a processor module 304 may be configured based on test cases to be performed. In this regard, the processor module 304 of the test bench 350 may control and/or interface with the MUT1 330 and other modules of the test bench 350 to coordinate the simulation. The processor module 304 may be configured by selecting one, 312_{X}, of a plurality of processor modules 312₁-312_{N}, wherein each module 312₁-312_{N} comprises code suitable for running one or more test cases. The Processor module 312_{X} may be selected by, for example, one or more commands provided to the simulation software 210 by the user. In an exemplary embodiment of the invention, the selection may be made via one or more VHDL configuration constructs. Subsequent to step 506, the exemplary steps may advance to step 508.

In step 508, simulation may be started. In this regard, a user of the computing platform 214 running the simulation software may initialize the simulation. Subsequent to step 508, the exemplary steps may advance to step 510.

In step 510, during simulation, a signal source module may be configured based on test cases to be performed during the simulation. For example, the signal source module may comprise a plurality of signal source modules 320 each of which corresponds to a different wireless protocol such as UMTS release 99, HSDPA, HSUPA, and LTE. Subsequent to step 510, the exemplary steps may advance to step 512.

In step 512, a test case for testing the MUT1 may be performed. In this regard, the signal source module may generate data corresponding to wireless communication signals. The generated data may be communicated to one or more RF processor modules and/or to the MUT1. The MUT1 may receive the data and generate corresponding data. The corresponding data may be provided to the processor module, may be compared to expected or known good data, and/or may be output such that a user may verify the corresponding data. Subsequent to step 512, the exemplary steps may advance to step 514. The processor module may control the exchange of data between the modules.

In step 514, it may be determined whether test cases for the current simulation have been completed. In instances that there are additional test cases, the exemplary steps may return to step 506. In instances that the test cases for the current simulation have completed, then the exemplary steps may advance to step 516.

In step 516, simulation data and/or results may be output to a user and/or written to one or more files. In some embodiments of the invention, additional processing of data generated during simulation may be further processed on the computing platform.

Aspects of a method and system for simulation and verification of communication devices are provided. In an exemplary embodiment of the invention, a wireless communication system 100 that comprises at least a wireless signal source 102 and a wireless communication device 104 may be simulated utilizing a plurality of configurable modules that comprises: a MUT1 330, a processor module 304, and a signal source module 306. The MUT1 330 may model at least a portion of a design and/or functionality of the wireless communication device 104. The processor module 304 may comprise a plurality of processor modules 312₁-312_{N} and may model operation of a processor, such as an ARM processor. The signal source module 306 may comprise a plurality of signal source modules 320₁-320ₘ and may model operation of the wireless signal source 102. The processor module 304 may be dynamically programmed during the simulation such that a subset of the plurality of processor modules 312₁-312_{N} is selected and utilized for the simulation of the wireless communication system. The subset of the processor modules 312₁-312_{N} may be selected based on test cases to be performed for the simulation. The selection of the subset of the processor modules 312₁-312_{N} may be performed without recompiling the processor module 304. The signal source module 306 may be dynamically programmed during the simulation such that a subset of the plurality of signal source modules 320 is selected and utilized for the simulation. The subset of signal source modules 320 may be selected based on characteristics of the signal source 102 to be modeled. The selection of the subset of signal source modules 320 may be performed without recompiling the signal source module 306. Each of the processor modules 312 and/or the signal source modules 320 may be defined by a VHDL entity-architecture pair.

During the simulation, the processor module 304 may control and/or interface with other ones of the plurality of configurable modules, such as the MUT1 330 and the signal source module 306. The signal source module 306 may model a base station, and the signal source module 306 may be programmed during simulation based on one or more wireless protocols utilized by the modeled base station. Exemplary wireless protocols comprise GSM, EDGE, UMTS, HSDPA, HSUPA, WiMAX, LTE, and CDMA2000. During the simulation, the processor module 304 may provide parameters of a wireless signal to the signal source module 306, and the signal source module 306 may generate data corresponding to one or more frames of the wireless signal based on the parameters. The design and/or functionality of the communication device 104 to be tested may comprise at least a first subsystem 323a coupled to an input of the communication device 104 and a second subsystem 332b having an input coupled to an output of the first subsystem 332a. The MUT1 330 may comprise at least one test multiplexer module 308 that may enable simulating an input signal 323 of the communication device bypassing the first subsystem 332a and being applied to the second subsystem 332b.

The plurality of modules may comprise a reference module 358 that models the design, operation and/or functionality of the communication device 104 to be tested. The reference module 358 may be defined utilizing a software programming language, and simulation results from the reference module 358 may be compared to simulation results from the MUT1 330. The plurality of modules may be compiled prior to simulating the wireless communication system 100. During simulation, data corresponding to states and/or parameters of the MUT1 330 may be provided to the processor module, and the processor module may compare the data to expected data.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for simulation and verification of communication devices.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for design testing, the method comprising:
performing by one or more processors of a computing system:
simulating a wireless communication system that comprises at least a wireless signal source and a wireless communication device, wherein said simulation utilizes a plurality of configurable modules that comprises:
a module under test that models at least a portion of said design of said communication device design to be tested;
a processor module that models operation of a processor; and
a signal source module that models operation of said wireless signal source; and
dynamically programming one or more of said plurality of configurable modules without recompiling.

2. The method according to claim 1, wherein, during said simulation, said processor module controls and/or interfaces with other ones of said plurality of configurable modules.

3. The method according to claim 1, wherein said signal source module models a base station, and said signal source module is programmed during said simulation based on one or more wireless protocols utilized by said modeled base station.

4. The method according to claim 3, wherein said wireless protocols comprise GSM, EDGE, UMTS, HSDPA, HSUPA, WiMAX, LTE, and CDMA2000.

5. The method according to claim 3, wherein, during said simulation, said processor module provides parameters of a wireless signal to said signal source module, and said signal source module generates data corresponding to one or more frames of said wireless signal based on said parameters.

6. The method according to claim 1, wherein:
said design of said communication device to be tested comprises at least a first subsystem coupled to an input of said communication device, and a second subsystem having an input coupled to an output of said first subsystem; and
said module under test comprises at least one test multiplexer module that enables simulating an input signal of said communication device bypassing said first subsystem and being applied to said second subsystem.

7. The method according to claim 1, wherein:
said plurality of modules comprises a reference module that models said design of said communication device to be tested;
said reference module is defined utilizing a software programming language; and
simulation results from said reference module are compared to simulation results from said module under test via said one or more processors.

8. The method according to claim 1, comprising compiling said plurality of modules prior to said simulation of said wireless communication system.

9. The method according to claim 1, wherein, during said simulation of said wireless communication system, data corresponding to states and/or parameters of said module under test are provided to said processor module, and said processor module compares said data to expected data.

10. The method according to claim 1, wherein each of said processor module and said signal source module is defined by a plurality of VHDL entity-architecture pair.

11. The method according to claim 10, comprising dynamically programming said processor module during said simulation, without recompiling said processor module, based on one or more test cases for said simulation such that a subset of said plurality of VHDL entity-architecture pairs is selected and utilized for said simulation.

12. The method according to claim 10, comprising dynamically programming said signal source module during said simulation, without recompiling said signal source module, based on characteristics of a signal source to be modeled during said simulation such that a subset of said plurality of VHDL entity-architecture pairs is selected and utilized for said simulation.

13. A system for design testing, the system comprising:
one or more processors and one or more memory elements for use in a computing system, wherein said one or more processors and said one or more memory elements interoperate to:
simulate a wireless communication system that comprises at least a wireless signal source and said wireless communication device, wherein said simulation utilizes a plurality of configurable modules that comprises:
a module under test that models at least a portion of said design of said communication device design to be tested;
a processor module that models operation of a processor; and
a signal source module that models operation of said wireless signal source; and
dynamically programming one or more of said plurality of configurable modules without recompiling.

14. The system according to claim 13, wherein, during said simulation, said processor module controls and/or interfaces with other ones of said plurality of configurable modules.

15. The system according to claim 13, wherein said signal source module models a base station, and said signal source module is programmed during said simulation based on one or more wireless protocols utilized by said modeled base station.

16. The system according to claim 15, wherein said wireless protocols comprise GSM, EDGE, UMTS, HSDPA, HSUPA, WiMAX, LTE, and CDMA2000.

17. The system according to claim 15, wherein, during said simulation, said processor module provides parameters of a wireless signal to said signal source module, and said signal source module generates data corresponding to one or more frames of said wireless signal based on said parameters.

18. The system according to claim 13, wherein:
said design of said communication device to be tested comprises at least a first subsystem coupled to an input of said communication device, and a second subsystem having an input coupled to an output of said first subsystem; and
said module under test comprises at least one test multiplexer module that enables simulating an input signal of said communication device bypassing said first subsystem and being applied to said second subsystem.

19. The system according to claim 13, wherein:
said plurality of modules comprises a reference module that models said design of said communication device to be tested;
said reference module is defined utilizing a software programming language; and
simulation results from said reference module are compared to simulation results from said module under test via said one or more processors.

20. The system according to claim 13, wherein said one or more processors and said one or more memory elements interoperate to compile said plurality of modules prior to said simulation of said wireless communication system.

21. The system according to claim 13, wherein, during said simulation of said wireless communication system, data corresponding to states and/or parameters of said module under test are provided to said processor module, and said processor module compares said data to expected data.

22. The system according to claim 13, wherein each of said processor module and said signal source module is defined by a plurality of VHDL entity-architecture pair.

23. The system according to claim 13, wherein said one or more processors and said one or more memory elements interoperate to dynamically program said processor module during said simulation, without recompiling said processor module, based on one or more test cases for said simulation such that a subset of said plurality of VHDL entity-architecture pairs is selected and utilized for said simulation.

24. The system according to claim 13, wherein said one or more processors and said one or more memory elements interoperate to dynamically program said signal source module during said simulation, without recompiling said signal source module, based on characteristics of a signal source to be modeled during said simulation such that a subset of said plurality of VHDL entity-architecture pairs is selected and utilized for said simulation.
